(19) United States
(12) Patent Application Publication
(10) Pub. No.: US 2009/0179776 A1
(43) Pub. Date: Jul. 16, 2009

(54) DETERMINATION OF PARKING SPACE AVAILABILITY SYSTEMS AND METHODS

(76) Inventor: Johnny Holden, Seattle, WA (US)

Correspondence Address: AXIOS LAW GROUP. PLLC, 1525 4TH AVE, STE 800, SEATTLE, WA, 98101-1648, US

(21) Appl. No.: 12/354,718

(22) Filed: Jan. 15, 2009

Related U.S. Application Data
(60) Provisional application No. 61/021,137, filed on Jan. 15, 2008.

(51) Int. Cl. G08G 1/14

(52) U.S. Cl. 340/932.2

(57) ABSTRACT

Systems and methods are provided herein that provide for the determination and presentation of parking space availability to a user. In one exemplary embodiment, the availability status of a plurality of parking spaces can be determined by receiving a real-time image of a parking space and comparing the image to a stored control image of the parking space, which thereby determines whether the parking space is occupied. In further embodiments, the availability status of a parking space can be updated by generating an image of the parking space at various time intervals, determining the availability status of the parking space, and updating the status of the parking space.

This application claims priority to U.S. Provisional Application 61/021,137 filed Jan. 15, 2008 entitled DETERMINATION OF PARKING SPACE AVAILABILITY SYSTEMS AND METHODS. The foregoing application is hereby incorporated by reference in its entirety as if fully set forth herein.

### FIELD

This invention relates generally to vehicles, and more specifically, to systems and methods for the determination of parking space availability.

### BACKGROUND

Parking spaces have existed ever since vehicles have existed, and even before. When animals were the preferred mode of transportation, either through riding or the pulling of a vehicle, both the animal and any associated vehicle, used spaces to “park.” The advent of motorized vehicles and an increasing density of metropolitan areas further complicated access to vehicle parking by making it difficult to efficiently park a large number of vehicles in a relatively limited amount of space.

Commonly, areas designated for the parking of vehicles, such as cars, are know as “parking spaces” and are commonly designated by lines painted on the ground or road. Parking spaces can be located in a number of locations including on the sides of streets and in parking lots or in parking garages where many parking spaces are grouped together in a single structure or area.

Often, in densely populated areas, finding a place to park a vehicle can be a frustrating and time consuming endeavor. At certain times of the day, it is not uncommon for it to take a long time to find a suitable parking space. Many drivers must hunt for a place to park until they find an available parking space. In other words, a driver drives up and down a number of streets until they find an open space, or until they see a person who is about to vacate a space. This method of finding a parking space is far from ideal, because parking spaces can become available and taken within a matter of minutes, and the driver may be searching other areas when this occurs. Additionally, driving around to find a parking space is also inefficient because drivers who are hunting for a parking space commonly drive slowly so as to have more time to spot an open parking space or to spot a vehicle that is leaving a space. Accordingly, slow drivers that are searching for parking cause traffic congestion in areas where parking is limited, which further exacerbates issues with motor vehicles in metropolitan areas.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of a system of interconnected devices that facilitate the determination of parking space availability, in accordance with various embodiments.

FIG. 2 is a block diagram of a device that provides an exemplary operating environment for various embodiments.

FIG. 3 is a diagram illustrating the actions taken by an imaging device and a parking server in accordance with various embodiments.

FIG. 4 is a flow diagram illustrating a routine for obtaining a control parking space image in accordance with various embodiments.

FIG. 5 is a diagram illustrating the actions taken by an imaging device and a parking server in accordance with various embodiments.

FIG. 6 is a flow diagram illustrating a routine for monitoring the availability status of a parking space in accordance with various embodiments.

FIG. 7 is a diagram illustrating the actions taken by a user device, an imaging device and a parking server in accordance with various embodiments.

FIG. 8 is a flow diagram illustrating a routine for presenting the availability status of a parking space to a user in accordance with various embodiments.

### DESCRIPTION

Illustrative embodiments presented herein include, but are not limited to, systems and methods for the determination of parking space availability.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

The following is a description of systems and methods for determining the determination of parking space availability. Disclosed herein are exemplary systems of interconnected devices and individual devices that can perform the methods of certain embodiments. Also disclosed are sets of exemplary communications, made by the exemplary devices, to enable determination of the availability status of a parking space according to one embodiment. Furthermore, several exemplary methods for determination of parking space availability are described herein, which can be performed by one or more of the exemplary devices.

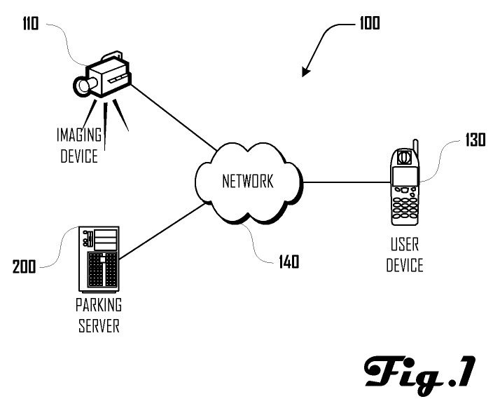

FIG. 1 is a pictorial diagram of a system of interconnected devices 100 that facilitate the determination of parking space availability, in accordance with various embodiments. The system 100 comprises an imaging device 110, a parking server 200, and a user device 130, which are operationally connected via a network 140. In one embodiment, the imaging device 110 can be any type of imaging device 130, such as a digital camera, film camera, digital video camera, film video camera, analog video camera, or the like. In another embodiment, the user device can be a personal data assistant, cellular telephone, computer, or the like.

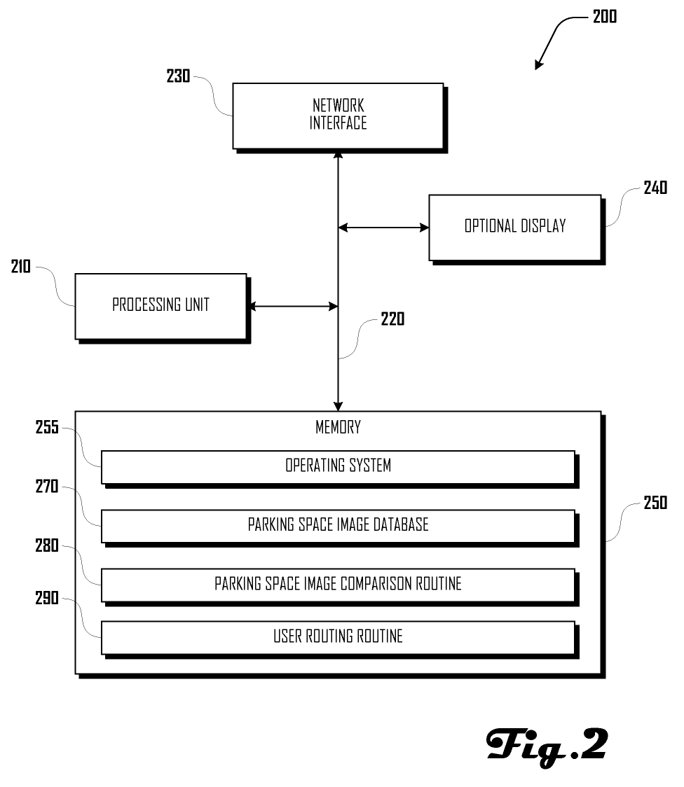

FIG. 2 illustrates several components of an exemplary operating environment 200 for an embodiment. For example, the parking server 200 can be embodied in the operating environment 200 depicted in FIG. 2. Those of ordinary skill in the art and others will appreciate that the operating environment 200 may include many more components than those shown in FIG. 2. However, it is not necessary that all of these generally conventional components be shown in order to disclose an enabling embodiment for practicing the embodiments described herein. As shown in FIG. 2, the operating environment 200 includes a network interface 230 for connecting to remote devices (not shown). The network interface 230 may be a network interface designed to support a local area network (“LAN”), wireless local area network (“WLAN”), personal area network (“PAN”), telephone network, powerline connection, serial bus, universal serial bus (“USB”) wireless connection, or the like. The network interface 230 includes the necessary circuitry, driver and/or transceiver for such a connection and is constructed for use with the appropriate protocols for such a connection.

The operating environment 200 also includes a processing unit 210, an optional display 240 and a memory 250, all interconnected along with the network interface 230 via a bus 220. Those of ordinary skill in the art and others will appreciate that the display 240 may not be necessary in all forms of computing devices and, accordingly, is an optional component. The memory 250 generally comprises random access memory (“RAM”), a read only memory (“ROM”) and a permanent mass storage device, such as a disk drive, flash RAM, or the like. The memory 250 stores the program code necessary for a parking space image comparison routine 280 and a parking space routing routine 290. Additionally, the memory 250 stores an operating system 255 and a parking space image database 270.

It will be appreciated that the software components may be loaded from a computer readable medium into memory 250 of the operating environment 200 using a drive mechanism (not shown) or network mechanism (not shown) associated with the computer readable medium, such as a floppy, tape, digital video disc (DVD)/CD-ROM drive, flash RAM, network interface card, or the like.

Although an exemplary operating environment 200 has been described that generally conforms to conventional general-purpose computing device, those of ordinary skill in the art will appreciate that a operating environment 200 may be any of a great number of devices capable of functioning as a device, server or operating environment that is within the spirit or scope of the embodiments described herein or can perform at least one function of the embodiments described herein.

In one exemplary embodiment, a user device 110 can configure or interact with the operating environment 200 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to operating environment 200 (e.g., displayed on the peer to peer display 240) may be made familiar and user friendly.

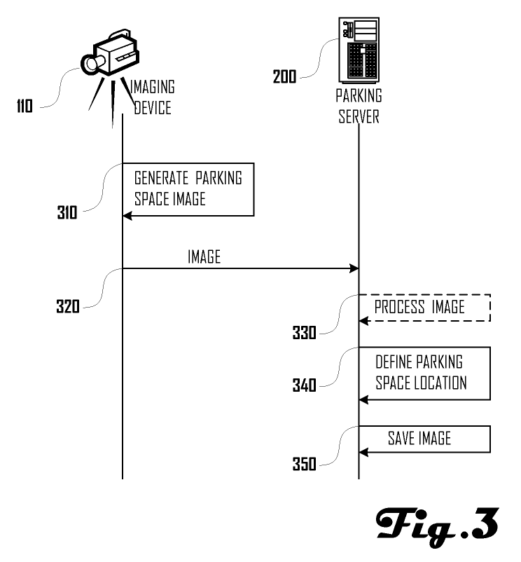

FIGS. 3 through 8 below disclose exemplary communications and methods that can be performed by one or more of the systems and/or devices disclosed herein, in accordance with certain embodiments. Various methods and communications can be employed to obtain one or more control parking space image, monitor the availability status of one or more parking space, and present the availability status of one or more parking space to a user. In one embodiment, exemplary methods and communications are employed with a plurality of users, user devices 130, parking spaces, parking servers 200, and imaging devices 110.

FIG. 3 is a diagram illustrating the actions taken by an imaging device 110 and a parking server 200 in accordance with various embodiments, which facilitate the generation of a control parking space image. The actions begin where a parking space image is generated 310 by an imaging device 110, and the image is sent 320 to the parking server 200. Then, in an optional step, the image is processed 330, the location of the parking space depicted in the image of the parking space is defined 340, and then the image is saved 350.

In one embodiment, the image can be processed 330 by the parking server 200 using editing, configuration, or modification techniques including, but not limited to, cropping, changing the brightness, changing the contrast, changing the color saturation, changing the size of the image, adding or removing from the image, zooming in and out, rotating the image, adding a grid system to the image, or the like. In one embodiment, an administrator or user can edit an image to conform with or match a template.

In one embodiment, the location of a parking space depicted in a parking space image can be defined 340 by global positioning system (“GPS”) coordinates, a street address, relation to one or more landmark, or a combination thereof. For example, a parking space can be defined as being on the west side of 4th Street, between Pike Street and Pine Street, and 30 feet from the intersection of Pine Street and 4th Street.

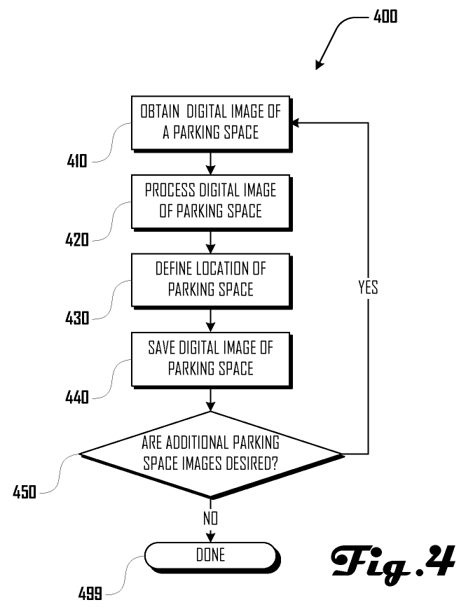

FIG. 4 is a flow diagram illustrating an exemplary control image routine 400 in accordance with various embodiments. The control image routine 400 begins in block 410, where a digital image of a parking space is obtained, and proceeds to block 420, where the digital image of the parking space is processed. In block 430, the location of the parking space depicted in the parking space image is defined, and the digital image of the parking space is then saved in block 440. In decision block 450, a determination is made whether additional parking space images are desired, and if so, the control image routine 400 cycles back to block 410 where a digital image of another parking space is obtained. However, if no additional images of parking spaces are desired, the control image routine 400 proceeds to block 499, where the control image routine 400 is done.

In one embodiment, the control image routine 400 can be used to populate a database of control parking space images, which can be stored on a parking server 200. For example, where the parking spaces on both sides of a street need to be documented, digital images of each parking space can be obtained 410 for each parking space. In one embodiment, one or more control parking space image can be generated for a given parking space. In another embodiment, there can be a plurality of imaging devices 110 in a stationary or moving position that can obtain one or more images of a parking space and an image of a given parking space can be generated 410 by one or more of the imaging devices 110.

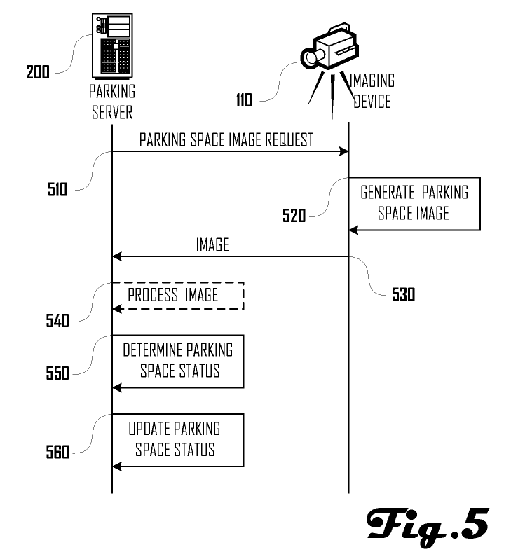

FIG. 5 is a diagram illustrating the actions taken by an imaging device 11 0 and a parking server 200, which can facilitate updating the availability status of a parking space in accordance with various embodiments. The actions begin with the parking server 200 requesting 510 an image of a parking space. Then, the imaging device 110 generates 520 a parking space image, and sends 530 the image to the parking server 200, which can process 540 the image in an optional step. Processing of the image can be by any process or method described herein, or otherwise, and in one embodiment, the image can be processed to conform with a template or a control parking space image.

Returning to the actions, the availability status of the parking space is then determined 550 and the availability status of the parking space is updated 560. In one embodiment, the availability status of the parking space can be determined by comparing the image of the parking space to a control parking space image to determine if a vehicle or other object is present within the area defining the parking space. In another embodiment, an analysis can be made of the parking space image to determine if there is a vehicle or other object in the space defining the parking space. For example, where a parking space is on a street, one or more marking can be painted on the street within the boundaries of the parking space, and an analysis of the parking space image can determine the presence or absence of the one or more marking, where absence of one or more marking in the image may suggest a vehicle or other object being in the parking space.

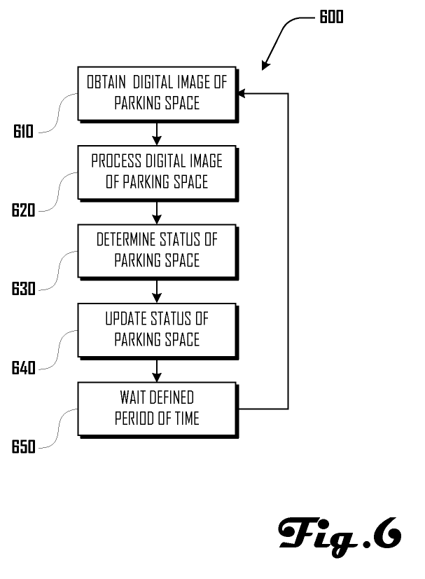

FIG. 6 is a flow diagram illustrating an exemplary availability monitoring routine 600, in accordance with various embodiments. The availability monitoring routine 600 begins in block 610, where a digital image of a parking space is obtained, and proceeds to block 620 where the digital image of the parking space is processed. The status of the parking space is determined in block 630, and the availability monitoring routine 600 proceeds to block 640, where the availability status of the parking space is updated. In block 650, a defined period of time is allowed to expire, and the availability monitoring routine 600 cycles back to block 610, where a digital image of the parking space is again obtained.

For example, in one embodiment, the status of a parking space can be updated each minute, such that the availability status of the parking space remains relatively up-to-date and accurate. In another embodiment, there can be a plurality of imaging devices 110, which can monitor the availability status of a plurality of parking spaces. The interval between updating the status of a given parking space can be any period of time, and can be in increments of milliseconds, minutes, hours, days or any fractions of any of these measurements of time. Additionally, the rate at which the availability status of a plurality of parking spaces is updated can be the same or different.

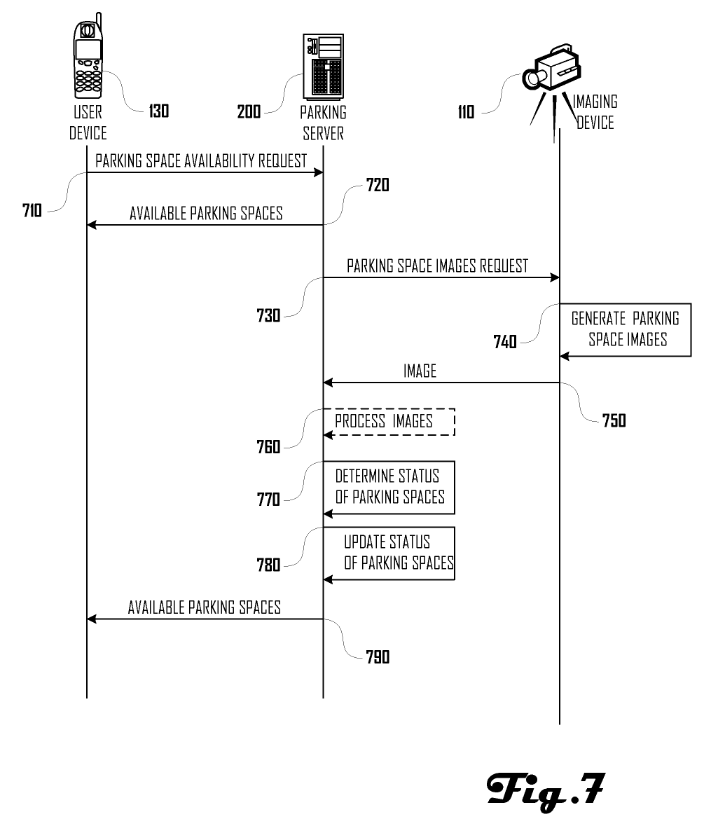

FIG. 7 is a diagram illustrating the actions taken by a user device 130, an imaging device 110 and a parking server 200, which can facilitate the presentation of the availability status of a parking space to a user in accordance with various embodiments. The actions begin where a user device 130 requests 710 the availability status of at least one parking space and the parking server 200 presents 720 available parking spaces to the user device 710. Next, the parking server 200 requests 730 parking space images of the parking spaces from the imaging device 110, and the imaging device 110 generates 740 parking space images of the parking spaces, and sends 750 the images to the parking server 200, where the parking server 200 can optionally process 760 the images. Then, the availability status of the parking spaces is determined 770 and the status of the parking spaces is updated 780. Available parking spaces are then presented 790 to the user device.

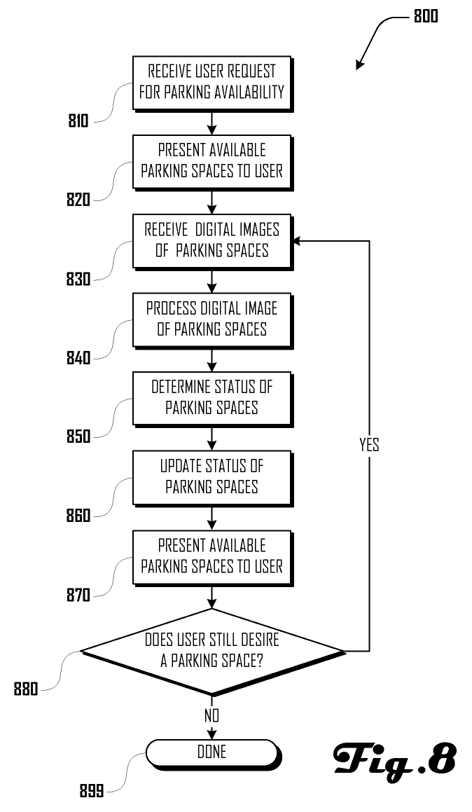

FIG. 8 is a flow diagram illustrating an exemplary availability status presentation routine 800 in accordance with various embodiments. The availability status presentation routine 800 begins in block 810, where a request is received for the availability status of at least one parking space, and proceeds to block 820, where the availability of available parking spaces is presented a user. In block 830, digital images of all requested parking spaces are received and processed in block 840. The availability status presentation routine 800 proceeds to block 850, where the status of the parking spaces is determined, and proceeds to block 860, where the status of the parking spaces is updated, and next to block 870, where the availability status of available parking spaces is presented to the user. In decision block 880, a determination is made whether the user still desires to find a parking space, and if so, the availability status presentation routine 800 cycles back to block 830, where digital images of the parking spaces are again received. However, if the user no longer desires to obtain a parking space, the availability status presentation routine 800 moves to block 899, where the availability status presentation routine 800 is done.

For example, in one embodiment, a user can be traveling to a destination in a metropolitan downtown area, and can configure a user device 130 to request the availability status of all parking spaces within five blocks of the destination. The user can receive the most current status of the parking spaces within the given radius, and then the availability of all parking spaces within the given radius can be updated until the user no longer desires a parking space.

In another embodiment, a user device 130 can present a map of a given area, and further present the location of available parking spaces on the map, and the status of the parking spaces depicted on the map can be updated. In a still further embodiment, a user device 130 can present directions on how to locate one or more available parking space in audio, or visual format, or a combination thereof. In a still further embodiment, a user device 130 can present one or more image or video of a parking space.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. Therefore, it is manifested and intended that the invention be limited only by the claims and the equivalents thereof. While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined by reference to the claims that follow.

1. A computer implemented method for presenting the availability status of at least one parking space to a user, the method comprising:
recieving a request for available parking spaces from a user;
obtaining a first real-time parking space image of a first parking space;
comparing the first real-time parking space image to a first control parking space image stored in a database;
determining the availability status of the first parking space based on the comparison of the first real-time parking space digital image to the first control parking space image; and
presenting the availability status of the first parking space to the user.

2. The method of claim 1, the method further comprising:
obtaining a second real-time parking space image of a second parking space;
comparing the second real-time parking space image to a second control parking space image stored in a database;
determining the availability status of the second parking space based on the comparison of the second real-time parking space digital image to the second control parking space image; and
presenting the availability status of the second parking space to the user.

3. A computer implemented method for updating the availability status of at least one parking space, the method comprising:
obtaining a first real-time parking space image of a first parking space;
comparing the first real-time parking space image to a first control parking space image stored in a database;
determining the availability status of the first parking space based on the comparison of the first real-time parking space digital image to the first control parking space image; and,
updating the availability status of the parking space, wherein the availability status is stored in a database.

4. A computer implemented method for generating a database of control parking space images for presenting the availability status of at least one parking space to a user, the method comprising:
obtaining a plurality of control parking space images, wherein each control parking space image depicts a parking space;
defining the location of each parking space depicted in each of the control parking space images;
storing the plurality of control parking space images and associated defined locations.
